(19) United States
(12) Patent Application Publication
(10) Pub. No.: US 2004/0007683 A1
(43) Pub. Date: Jan. 15, 2004

(54) Hydraulic actuated vapor recovery valve

(75) Inventor: Joel Lee Willetts, Russell, PA (US)

Correspondence Address: HAHN LOESER & PARKS, LLP, TWIN OAKS ESTATE, 1225 W. MARKET STREET, AKRON, OH, 44313, US

(73) Assignee: Betts Industries, Inc.

(21) Appl. No.: 10/603,639

(22) Filed: Jun. 25, 2003

Related U.S. Application Data
(60) Provisional application No. 60/395,541, filed on Jul. 12, 2002.

(51) Int. Cl. F16K 31/163

(52) U.S. Cl. 251/63.6

(57) ABSTRACT

A hydraulic vapor recovery valve comprising a valve body, a top head assembly, and means for demountably attaching the a top head assembly to the valve body. The top head assembly can be removed from the valve body assembly without requiring substantial rotation of the top head assembly which enables the valve to be easily be removed for cleaning without requiring removal of any attached hydraulic lines.

This application claims the benefit of U.S. Provisional Patent Application Serial No. 60/395,541 filed Jul. 12, 2002, and is hereby incorporated by reference. The present invention relates generally to a vapor recovery valves and more particularly, to a vapor recovery valve for use on tank trailers and the like which is hydraulically actuated and can easily be removed for cleaning without requiring removal of any attached hydraulic lines.

### FIELD OF THE INVENTION

### BACKGROUND OF THE INVENTION

Environmental concerns have led to a requirement for the reduction of chemical vapors, particularly hydrocarbons emitted into the atmosphere from every possible source. These sources include bulk loading and unloading terminals, tankers, underground storage tanks, etc. In these applications a vapor recovery system is used to gather the air containing hydrocarbons or other vapors which are emitted during loading and unloading operations.

Vapor recovery systems are designed to collect or capture the vapors released and/or generated during the dispensing, transfer and/or storage of liquids, and are capable of returning displaced vapors and air from the vessel being filled back to the storage container and/or a vapor reduction device. Cargo tankers used to transport various hazardous liquid chemicals or the like must typically be cleaned after every load. This requires that all valves and hardware that comes into contact with the tank lading be cleaned as well.

On traditional hydraulic vapor recovery valves, to clean the internal components of the valve, the valve must either be removed from the tank and disassembled or left on the tank and means provided to clean the inside. Currently, the best option available to the industry is to leave the valve on the tank and access the internal components of the valve by removing the top head of the valve by unscrewing the head from the valve body. However, this method requires the removal of the hydraulic line connected to the top head of the valve. Removal/reattachment of the hydraulic lines takes additional time and can result in spillage of hydraulic fluid, requiring additional clean up. The frequent removal/reattachment of the top head may result in damaged threads requiring replacement of the top head or valve.

These and other problems in the prior art reveal the need for a new hydraulic vapor recovery valve which overcomes one or more of the above mentioned problems.

### SUMMARY OF THE INVENTION

It is an object of the invention to provide an improved hydraulic vapor recovery valve having features that enable the valve to be easily cleaned without removal of the attached hydraulic line which overcomes one or more of the problems identified with the prior art. These and other advantages are provided by a hydraulic vapor recovery valve comprising: a valve body assembly; a top head assembly; a means for demountably securing the top head assembly to the valve body assembly, wherein removal of the means for demountably securing the top head assembly to the valve body assembly allows the top head assembly to be axially removed from the valve body assembly without requiring substantial rotation of the top head assembly. These and other objects of the invention will be apparent as described below and in relation to the drawings.

### BRIEF DESCRIPTION OF THE DRAWINGS

Better understanding of the present invention will be had when reference is made to the accompanying drawings, wherein identical parts are identified with identical reference numerals, and wherein:

FIG. 1 is a front side elevational view of a hydraulic vapor recovery valve of the present invention shown in the valve closed configuration;

FIG. 2 is a front side elevational view of a hydraulic vapor recovery valve of the present invention shown in the open configuration;

FIG. 3 is a side cross-sectional view of a hydraulic vapor recovery valve of the present invention shown in the valve closed configuration;

FIG. 4 is a side cross-sectional view of a hydraulic vapor recovery valve of the present invention shown in the valve open configuration; and

FIG. 5 is a top plan view of the hydraulic vapor recovery valve of the present invention.

### DETAILED DESCRIPTION OF THE DRAWINGS

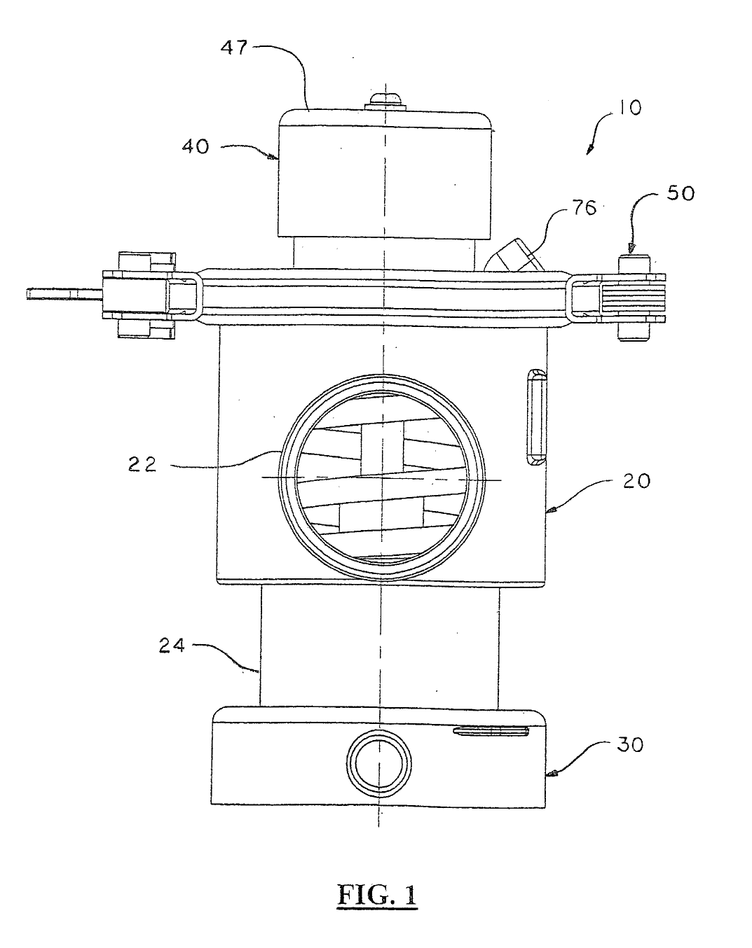

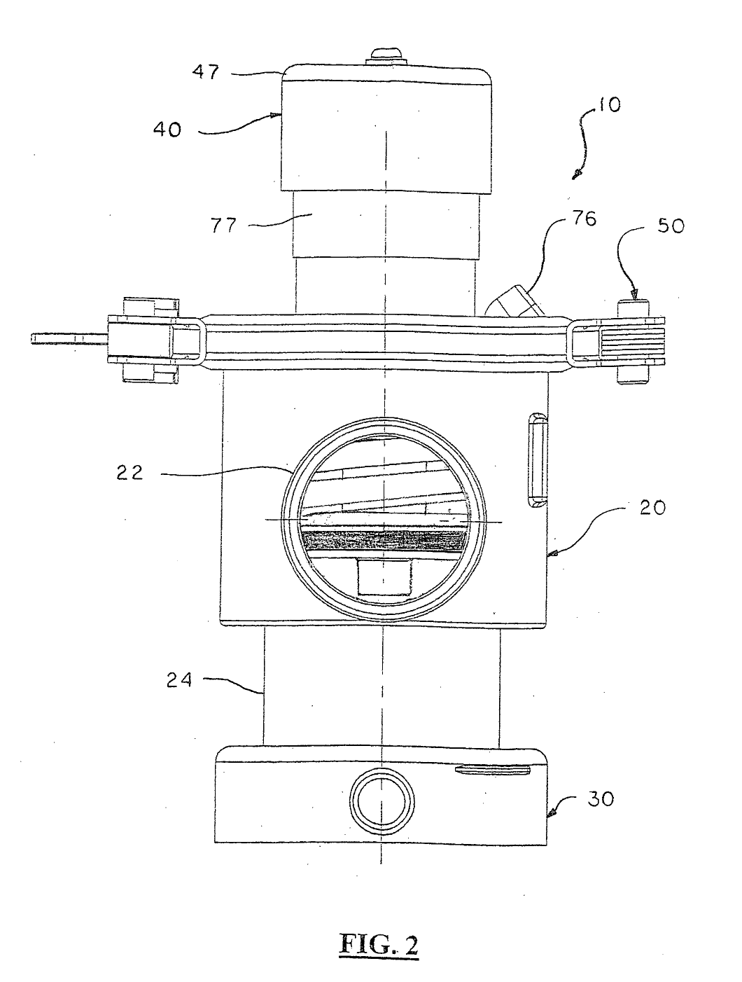

A front side elevational view of a hydraulic vapor recovery valve 10 of the present invention is shown in the valve closed position in FIG. 1 and in a valve open position in FIG. 2. Valve 10 comprises a body assembly 20 having a bottom opening portion 24 which is mountable to the top of a tank (not shown) using a N.P.T. fitting 30 or the like. Valve 10 comprises a top head assembly 40 (also referred to as the top head and cylinder assembly) attached to body 20 by a means 50 for demountably securing the top head portion 40 to the valve body assembly 20. Means 50 is depicted in FIG. 1 as a clamp ring assembly 50, however, the invention is not limited to the configuration shown. Any suitable fastening or attachment device which will allow the top head portion 40 to be generally axially removed from the valve body 20 without requiring removal of a hydraulic line attached to the top head portion 40 is contemplated. A clamp ring 50 provides a quick connect/disconnect fastening system which allows the axial separation of the top head portion 40 from the valve body 20. The top head portion 40 comprises a rain cap 47 which is telescopically extended upward in FIG. 2 revealing an indicator 77 which provides a signal that the valve is open as will be discussed in greater detail below. The valve 10 is hydraulically actuated. The top head portion 40 includes a hydraulic fluid port 76 which is connected to a fluid source by a hydraulic fluid line in the form of a hose or piping (not shown). The hydraulic fluid line is typically connected to fluid port 76 in a manner that prevents the top head portion 40 to be rotated, such as with a threaded connection. Depending on the fluid line configuration, a small amount of rotation might be possible such as with a bayonet type fitting connection which allows axial movement upon release of the bayonet. This is not considered to be a substantial amount of rotation that would require removal of the hydraulic lines, however, it is noted that some hydraulic lines systems may not permit any rotation.

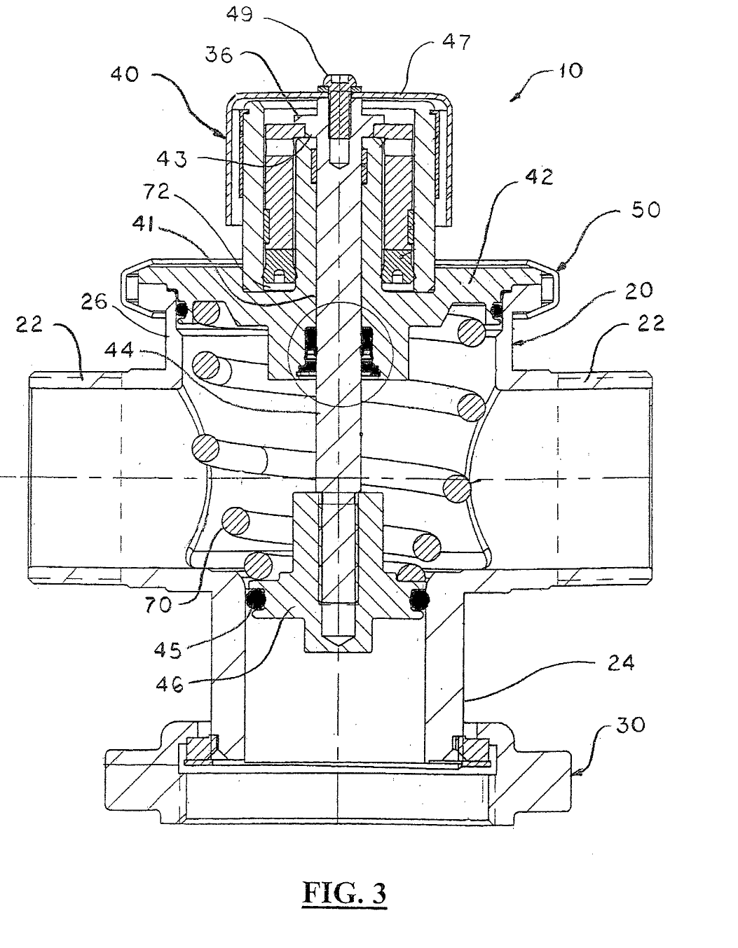

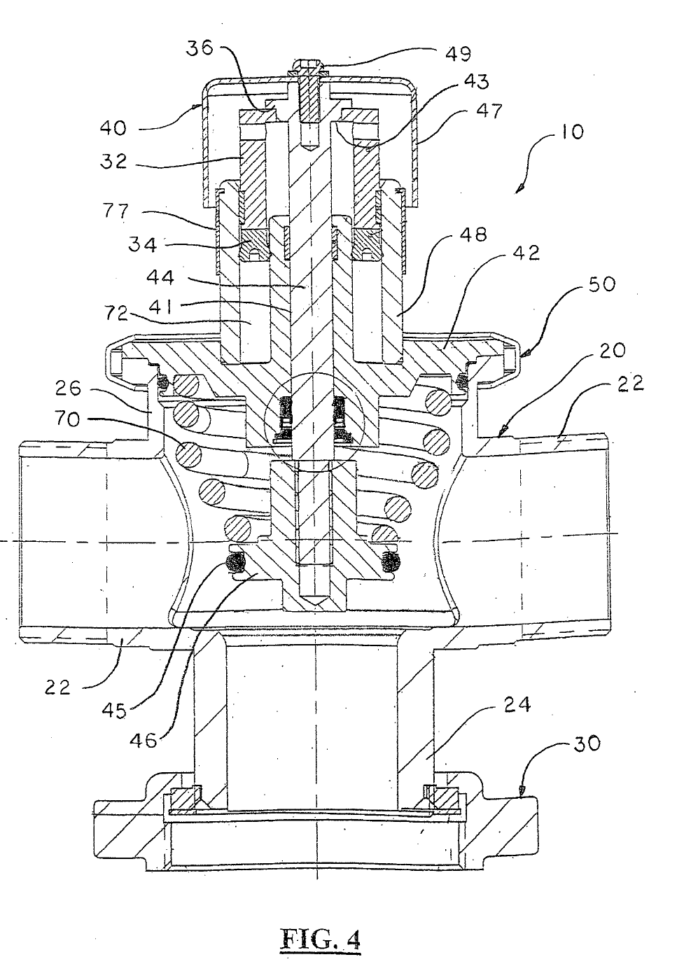

The valve body 20 is shown as a “T” style body having opposing male N.P.T. fittings 22 as best shown in FIG. 3 which provide a vapor passageway 22 for connection to a vapor recovery system or the like (not shown). The valve body 20 is not intended to be limited to any particular body style, for example, the body 20 could also be configured as an “L” or elbow style valve. The valve 10 is shown in a cross-sectional views in FIGS. 3 and 4 which reveals the interior components of valve 10 in the closed valve configuration in FIG. 3 in an open valve configuration in FIG. 4. The top head portion 40 of valve 10 comprises a stem portion 42 which mates with a top opening 26 in body 20. The stem 42 has a central aperture 41 therethrough which slidingly houses a piston rod 44. The piston rod 44 is attached to a holder member 46 which has a seal 45 which registers against the interior diameter of the bottom opening 24 and together seal the bottom opening 24 from the vapor passageway 22. The holder member 46 is biased in a sealing position by a spring 70 positioned between the stem 42 and the holder member 46. A flange 43 on the piston rod 44 registers against a top portion of the stem 42 to keep the spring 70 from fully extending and to retain the piston rod 44 in a proper sealing position. The piston rod 44 has rain cap 47 fixably attached by a fastener 49 at an end opposite the holder member 46.

The top head portion 40 further comprises a cylinder 48 fixably attached to stem portion 42. A piston 32 is positioned within cylinder 48 and has a hydraulic seal 34 positioned adjacent the bottom of the piston 32. The hydraulic seal 34 sealingly registers against the cylinder 48 and the stem 42. The piston 32 registers against a second flange 36 of the piston rod 44.

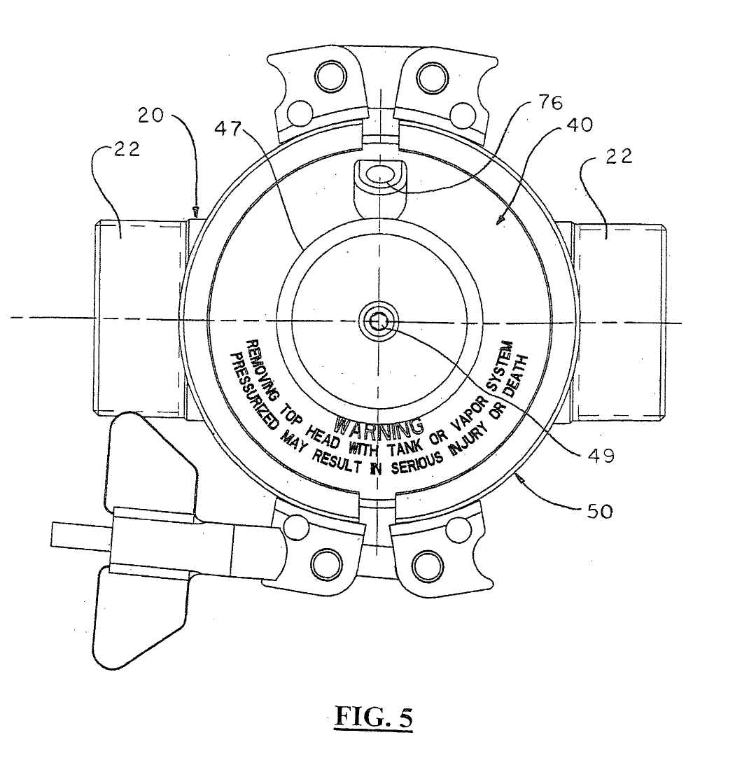

In operation, valve 10 is operated by hydraulic fluid which enters stem portion 42 through fluid port 76 as best shown in FIG. 5 which is a top plan view of valve 10. Referring now to FIGS. 3 and 4, the fluid (not shown) enters a pressure chamber 72 formed below the hydraulic seal 34 and forces the seal 34 upward. The seal 34 forces the piston 32 upward, which in turn pushes up the piston rod 44. The holder member 46 and seal 45 are moved upward with piston rod 44, compressing spring 70 and unsealing opening 24 and connecting the tank (not shown) to the vapor passageway 22. On the top of the valve 10, the piston rod 44 elevates the rain cap 47. The raising of the rain cap 47 exposes the outer surface of the cylinder 48 which is covered with an indicator 77 typically in the form of a red sleeve. The visible indicator 77 shows the user that the valve 10 is in an open position.

To close the valve 10, the hydraulic pressure is lowered to the point that the spring force of spring 70 forces the piston rod 44 downward. The opening 24 is resealed by the holder member 46 and seal 45. The piston rod 44 forces the piston 32 downward which forces the hydraulic seal 34 downward, expelling hydraulic fluid through port 76. The rain cap 47 moves downward with the piston rod 44 and covers the indicator 77 attached to cylinder 48, showing the operator that the valve 10 is in the closed position.

It is noted that the hydraulic seal 34 registers against the bottom of the piston 32 but is not attached to the piston 32. The seal 34 sealingly registers against the stationary cylinder 48 and the stationary stem 42. The cross-section of the seal 34 is generally U-shaped to promote the lips of the seal 34 to sealingly register against the stationary cylinder 48 and the stationary stem 42, however, the seal 34 is not limited to this configuration.

To remove the top head portion 40 from the valve body 20, the clamp ring assembly 50 is released and removed from the valve 10. As the tank or the system may be pressurized, care must be taken to ensure that the tank/system is no longer under pressure. Once the clamp ring assembly 50 is removed from valve 10, the entire top head portion 40 can now be removed vertically (axially along the axis of the piston rod) out of the top opening 26 of the valve body 20. Since no rotation of the top head portion 40 is required, such as when the head is threaded in the valve, the hydraulic hose (not shown) does not need to be disconnected from port 76. The elements of the top head portion 40 which were exposed to the lading vapors, specifically the spring 70, holder member 46, seal 45, the bottom of the stem 42, and the portion of the piston rod 44 extending below the stem 42, are now exposed and can be easily cleaned quickly and efficiently. The valve body 20 is easily cleaned with the top head portion 40 removed. Once clean, the top head portion 40 is replaced in the top opening 26 of the valve body 20 and the clamp ring assembly 50 repositioned and secured. The valve 10 is then ready for continued operation.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. A hydraulic vapor recovery valve comprising:
a valve body assembly;
a top head assembly;
a means for demountably securing the top head assembly to the valve body assembly, wherein removal of the means for demountably securing the top head assembly to the valve body assembly allows the top head assembly to be axially removed from the valve body assembly without requiring substantial rotation of the top head assembly.

2. The valve of claim 1, wherein the means for demountably securing the top head assembly to the valve body assembly comprises a clamp ring assembly.

3. The valve of claim 2, wherein the clamp ring assembly engages a flange of the top head assembly and a flange of the valve body assembly.

4. The valve of claim 2, wherein the top head assembly comprises a flange having a planar register surface and wherein the valve body assembly comprises a flange having a planar register surface, and wherein the clamp ring assembly clamps the register surface of the flange of the top head assembly against the register surface of the flange of the valve body assembly.

5. The valve of claim 1, wherein the valve body assembly is a “T” style valve.

6. The valve of claim 1, wherein the valve body assembly comprising an inlet for connection to a vapor source, an outlet for connection to a vapor recovery system and a valve opening for attachment of the top head assembly.

7. A hydraulic vapor recovery valve comprising:
a valve body assembly comprising an inlet for connection to a vapor source, an outlet for connection to a vapor recovery system and a valve opening for attachment of a top head and cylinder assembly;
the top head and cylinder assembly having at least one hydraulic fluid port;
a means for clamping the top head and cylinder assembly to the valve body assembly.

8. The valve of claim 7, wherein the means for clamping the top head and cylinder assembly to the valve body assembly comprises a clamp ring assembly.

9. The valve of claim 8, wherein the clamp ring assembly engages a flange of the top head assembly and a flange of the valve body assembly.

10. The valve of claim 8, wherein the top head and cylinder assembly comprises a flange having a planar register surface and wherein the valve body assembly comprises a flange having a planar register surface, and wherein the clamp ring assembly clamps the register surface of the flange of the top head and cylinder assembly against the register surface of the flange of the valve body assembly.

11. The valve of claim 1, wherein the valve body assembly is a “T” style valve.

12. A hydraulic vapor recovery valve comprising:
a valve body assembly comprising an inlet for connection to a vapor source, an outlet for connection to a vapor recovery system and a valve opening for attachment of a top head and cylinder assembly;
the top head and cylinder assembly comprising a hydraulic fluid port, a piston moveable in a cylinder, the piston engages a first end of a piston rod which is connected at a second end to a sealing plug which moves in conjunction with the piston from a first position wherein the sealing plug seals the inlet of the valve body and a second position which allows vapor to enter the valve body through the inlet; and
a means for demountably connecting the top head and cylinder assembly to the valve body wherein the top head and cylinder assembly is removable from the valve body without removal of an attached hydraulic fluid line from the hydraulic fluid port.

13. The valve of claim 12, wherein the means for demountably connecting the top head and cylinder assembly to the valve body assembly comprises a clamp ring assembly.

14. The valve of claim 13, wherein the clamp ring assembly comprises a first semi-annular U-shaped channel hingedly connected at a first end to a first end of a second semi-annular U-shaped channel wherein the open end of each U-shaped channel is oriented radially inward, wherein a second end of each semi-annular U-shaped channel is locked into position with an adjustable latch mechanism.

15. The valve of claim 12, wherein the removal of the means for connecting the top head and cylinder assembly to the valve body allows the top head and cylinder assembly to be generally axially removed from the valve body assembly.

16. The valve of claim 12, wherein the valve body assembly is a “T” style valve body having a second connection to the vapor recovery system.

17. A hydraulic vapor recovery valve comprising:
a valve body assembly comprising an inlet for connection to a vapor source, an outlet for connection to a vapor recovery system and a valve opening for attachment of a top head and cylinder assembly;
the top head assembly comprising a stem portion including a hydraulic fluid port, a piston moveable in a cylinder fixably attached to the stem portion, wherein the piston engages a first end of a piston rod which is connected at a second end to a sealing plug which moves in an axial direction of the piston rod in conjunction with the piston from a first position wherein the sealing plug seals the inlet of the valve body and a second position which allows vapor to enter the valve body through the inlet;
a means for demountably securing the top head assembly to the valve body assembly, wherein removal of the means for demountably securing the top head assembly to the valve body assembly allows the top head assembly to be generally axially removed from the valve body assembly without substantial rotation of the top head assembly.

18. The valve of claim 17, wherein the means for demountably securing the top head assembly to the valve body assembly comprises a clamp ring assembly.

19. A method for vapor recovery comprising the following steps:
providing a valve body assembly comprising an inlet for connection to a vapor source, an outlet for connection to a vapor recovery system and a valve opening for attachment of a top head and cylinder assembly;
providing a top head and cylinder assembly and axially inserting a portion of the top head and cylinder assembly into the valve opening of the valve body until a flange of the top head and cylinder assembly registers against a flange of the valve body;
attaching the top head and cylinder assembly to the valve body by clamping the flange of the top head and cylinder assembly to the valve body.

20. A method for cleaning a vapor recovery valve comprising a valve body and a top head and cylinder assembly partially inserted into the valve body and secured to the valve body, the method comprising the following steps:
removing a clamp ring from the vapor recovery valve to unsecure the top head assembly from the valve body;
axially moving the top head and cylinder assembly out of and away from the valve body without disconnecting a hydraulic line attached to the top head and cylinder assembly and thereby exposing the top head and cylinder assembly and the valve body; and
cleaning the exposed top head and cylinder assembly and the valve body using a predetermined cleaning agent.
